(19) United States
(12) Patent Application Publication
(10) Pub. No.: US 2004/0208978 A1
(43) Pub. Date: Oct. 21, 2004

(54) Novel lactic acid bacteria and bacteriocins produced therefrom, and method for processing fish and legume foodstuffs using the same and the products obtained thereby

(76) Inventors: Shann-Tzong Jiang, Taipei (TW); Li-Jung Yin, Taipei (TW)

Correspondence Address: SCULLY SCOTT MURPHY & PRESSER, PC, 400 GARDEN CITY PLAZA, GARDEN CITY, NY, 11530

(21) Appl. No.: 10/652,387

(22) Filed: Aug. 29, 2003

(30) Foreign Application Priority Data
Apr. 18, 2003 (TW) 092109120

(51) Int. Cl. A23L 1/325

(52) U.S. Cl. 426/643

(57) ABSTRACT

The present invention relates to novel strains Pediococcus pentosaceus YJL with the accession numbers FERM-BP 8450 (BCRC 910210) and Pediococcus pentosaceus YJS with the accession numbers FERM-BP 8449 (BCRC 910211). The present invention also provides a method for processing fish foodstuffs comprising using lactic acid bacteria and the fish foodstuffs obtained thereby. The present invention also provides a method for processing legume foodstuffs comprising using lactic acid bacteria and the legume foodstuffs obtained thereby. The present invention further provides bacteriocins produced from the strains. The present methods are capable of producing processed products with reduced growth of unwanted microorganisms, improved flavor and enhanced economic value. The pentocins are effective on the inhibition of unwanted microorganisms thereby insuring the foodstuff a good quality during storage.

Novel lactic acid bacteria and bacteriocins produced therefrom, and method for processing fish and legume foodstuffs using the same and the products obtained thereby

### FIELD OF THE INVENTION

The present invention provides two novel strains of lactic acid bacteria (LAB) and bacteriocins produced therefrom, a method for processing fish foodstuffs comprising using LAB and the products obtained thereby, and a method for processing legume foodstuffs comprising using LAB and the products obtained thereby. Specifically, the present invention provides novel strains of LAB isolated from meat, which find their use in processing fermented foodstuffs wherein fish or legume is used as raw material. Also, the present invention provides processed products with reduced growth of unwanted microorganisms, improved flavor and enhanced economic value. The present invention further provides bacteriocins produced from the novel LAB. The bacteriocins are effective on the inhibition of unwanted microorganisms thereby insuring the foodstuffs a good quality during storage.

### BACKGROUND OF THE INVENTION

Traditional foodstuffs gradually cannot meet the needs of consumers. There are lots of health foods and delicate foods in the markets; it is accordingly known that the development in food industry focuses on the manufacture of diverse, safe and functional foodstuffs.

LAB are a group of microorganisms capable of producing lactic acid from the fermentation of fermentable saccharides. In fermented products such as fermented vegetables, cereals, milks, meats etc., LAB are used as fermentation starter for enhancing nutrition of foodstuffs (Acton et al., 1977), for inhibiting the growth of pathogens in the intestines (Bacus and Brown, 1981), for increasing the availability of lactose (Siddons and Coates, 1985), for preventing cancer (Oda et al., 1983) and for lowing the cholesterols level. In fermentation process, through the action of LAB saccharides undergo glycolysis reaction to give products a unique flavor and on the other side, produce organic acids such as lactic acid, acetic acid etc. to in turn lower the pH value of products thereby inhibiting the growth of microorganisms so as to prolong the shelf life of the products. Further, some LAB can produce a variety of antimicrobial substances such as hydrogen peroxide, diacetyl compounds, bacteriocins etc. to inhibit the growth of saprogenic bacteria or pathogenic bacteria (Gibbs, 1987; Klaenhammer, 1988; Daeschel, 1989; Schillinger and Lucke, 1989).

LAB can produce substances which are able to inhibit the growth of pathogenic bacteria and which are mainly bacteriocins, diacetyl compounds, and hydrogen peroxide and secondary metabolic products. Bacteriocins are macromolecules containing proteins and having the activity on inhibiting the growth of microorganisms (Scbillinger and Holzapfel, 1996; Roller and Lusengo, 1997). LAB capable of producing bacteriocins include Lactobacillus fermentum (Deklerk and Smit, 1967) [symbol] Lactobacillus plantarum (Sedewitz et al., 1983) [symbol] Lactobacills helveticus (Joerger and Klaenhammer, 1986) [symbol] Lactobacillu acidophilus (Muriana and Klaenhammer, 1987) [symbol] Lactobacillu plantarum (West and Warner, 1988) and Pediococcus pentosaceus (Daeschel and Klaenhammer, 1985).

Bacteriocins produced by Pediococcus acidilactici are effective on inhibiting the growth of Listeria monocytogenes in fresh meats, fermented sausages, fermented cabbages, minced beef and cheeses (Nielsen et al., 1990; Choi and Beuchat, 1994; Motlagh et al., 1992; Parente et al., 1996; Vignolo et al., 1996; Cutter and Siragusa, 1996) so as to prolong the shelf life thereof in refrigeration. Bacteriocins produced by Lactobacillus lactis ATCC 11454, Pediococcus pentosaceus ATCC 43200 and Pediococcus pentosaceus ATCC 43201, when added into refrigerated processed foodstuffs containing 3-4% sodium chloride, can inhibit the germination and growth of Clostridium botulinum spores (Okereke and Montville, 1991). Bacteriocins produced by Lactococcus lactis and Pediococcus pentosaceous are effective on inhibiting the growth of Gram-positive pathogenic bacteria such as Bacillus cereus, Clostridium perfringenes, Staphylococcus aureus and Listeria monocytogenes as well as Gram-negative pathogenic bacteria such as Aeromonas hydrophila AH₂, Escherichia coli O157:H7, Vibrio cholerae 851 and V. parahaemolyticus A865957 (Spelhaug and Harlander, 1989; Helander et al., 1997). Nisin produced by Lactococcus lactis subsp. lactis has been categorized as GRAS (generally recognized as safe) by FDA in 1992 and can be used in refrigerated cheeses for the inhibition of the germination and growth of Clostridium botulinum spores.

LAB can also produce 2,3-butanedione and hydrogen peroxide (H₂O₂), besides bacteriocins. 2,3-Butanedione is a final product produced by LAB from the metabolic intermediate pyruvate (Kandler, 1983; Monnet et al., 1994). Jay (1982) reports that 2,3-butanedione can inhibit the growth of Gram-positive bacteria at 200 μg/mL. Though 2,3-butanedione is also on the FDA's GRAS list, it has a strong flavor and high volatility and thus should be used in a limited amount. Hydrogen peroxide is produced during the growth of LAB through the action of pyruvate oxidase, L-lactase and NADH oxidase respectively on pyruvate, lactose and NADH with oxygen (O₂) (Kandler, 1983; Sedewitz et al., 1983) so as to inhibit the growth of harmful microorganisms. Hydrogen peroxide can form well bacteriostatic substances with other materials, for example, an intermediate oxidized product formed from the action of lactoperoxidase on thiocyanate is capable of inhibiting the growth of microorganisms, thereby prolonging the shelf life of foodstuffs (Harnulv et al., 1982). The aforesaid pathway is called “lactoperoxidase antibacterial system”.

Bacteriocins produced by the genus Pediococcus include Pediocin AcH produced by Ped. acidilactici H, Pediocin PA-1 produced by Ped. acidilacthci PA1.0, and Pediocin A produced by Ped. pentosaceus FBB61. Further, bacteriocins produced by Ped. cerevesiae FBB63 and Ped. acidilactici PC are still not named.

Bhunia et al. (1988) isolated Ped. acidilactici strain H from fermented sausages. The strain is capable of producing Pediocin AcH with a molecular weight of about 2,700 Da (SDS-PAGE). As proved by experiments, the bacteriocin is effective on inhibiting the growth of the microorganisms including Lactobacilli, Leuconostocs, Staphylococcus aureus, Clostridium perfringens, Pseudomonas putida, Listeria monocytogenes etc. The bacteriocin is sensitive to proteolytic enzymes and is stable to heat. Since Pediocin AcH can act on cell membrane to cause the loss of potassium ion etc. from the cell thereby causing the degradation of the cell (Bhunia et al., 1991).

### SUMMARY OF THE INVENTION

In view of the teachings mentioned above, the inventors of the present invention has conducted elaborated research and found that novel strains Pediococcus pentosaceus YJL and Pediococcus pentosaceus YJS are effective on improving the processibility of legumes and fishes such as mackerel. Further, during fermentation the effect of the products produced by LAB on the quality (texture, flavor, appearance etc.) of fish meat and legumes and the effect of the proteinases produced by LAB on the texture of fish meat and legumes are studied so as to broaden the processing field of fishes and legumes and to enhance the applicability thereof. Further, the fermentation of fish meat or legumes by use of LAB under various conditions lead to products with various textures, colors, tastes and flavors because of the difference in the type of the substances produced and in the extent to which the proteinases produced act. As a result, the present invention provides novel technique in food processing through controlling fermenting conditions such that various novel products can be produced.

### BRIEF DESCRIPTION OF THE DRAWINGS

FIG. 1 shows the differentiation of pediococci from other Gram-positive bacteria.

FIG. 2 shows the SDS-PAGE (8-17.5% gradient polyacrylamide) of purified Pentocin YJL and Pentocin YJS.

FIG. 3 shows the photo of fermented fish cheeses prepared in Example 3.

FIG. 4 shows the photo of fish yogurt prepared in Example 3.

FIG. 5 shows the photo of soybean pudding prepared in Example 4.

### DETAILED DESCRIPTION OF THE INVENTION

Pediococcus pentosaceus YJL and Pediococcus pentosaceus YJS respectively were deposited in the International Patent Organism Depositary (IPOD), Japan according to the Budapest Treaty on Aug. 8, 2003 with the accession numbers FERM-BP 8450 and FERM-BP 8449. Also, the two strains were deposited in Bioresources Collection and Research Center (BCRC), Food Industry Research and Development Institute, Hsinchu, Taiwan on Jan. 9, 2003 with the accession numbers BCRC 910210 and BCRC 910211.

As described above, the present invention therefore provides the following aspects.

1. Pediococcus pentosaceus YJL with the accession numbers FERM-BP 8450 (BCRC 910210).

2. Pediococcus pentosaceus YJS with the accession numbers FERM-BP 8449 (BCRC 910211).

3. A method for processing fish meat wherein LAB of 1. or 2. or other LAB or mixed strains thereof is (are) used in fermenting the fish meat, comprising the steps of

homogenizing the fish meat with the addition of sodium chloride in an amount of 0.3-2.0 wt % (based on the weight of the fish meat) and water in an amount 0.5-3 times the weight of the fish meat to obtain a homogenous substrate;

sterilizing the homogenous substrate at a temperature of from 100 to 115° C. for 15 to 30 minutes and then cooling the same to a temperature of from 25 to 40° C.;

adjusting the water content of the substrate by diluting it with water at a dilution ratio of 0-5 times the weight of the substrate;

adding 1.0-6.0 wt % of a saccharide to the substrate and then inoculating the same with the LAB;

fermenting the substrate inoculated with the LAB at a temperature of from 25-40° C. for 6-30 hours;

optionally adding a seasoning and a spice; and

optionally packaging the resulting product.

4. The method of 3. wherein the other LAB is selected from the group consisting of Lactobacillus plantarum CCRC10069, Lactococcus lactis subsp. lactis CCRC 12315, and Lactobacillus helveticus CCRC 14092.

5. The method of 3. wherein the fish meat is at least one selected from the group consisting of red fish meat, white fish meat, frozen surimi and mixture thereof.

6. The method of 3. wherein the saccharide is at least one selected from the group consisting of sucrose, glucose and beet sugar.

7. The method of 3. wherein the substrate is a non-diluted or 5-fold-diluted surimi.

8. The method of 3. wherein the seasoning is at least one selected from the group consisting of fresh fruits, processed fruits, sesame and peanuts.

9. The method of 3. wherein the spice is at least one selected from the group consisting of ginger, garlic, mirin, wine, and prickly ash.

10. The method of 3. wherein the substrate after being fermented has a pH value of from 3.8 to 5.5.

11. A processed fish foodstuff obtained from fish meat fermented with LAB of 1. or 2. or other LAB or mixed strains thereof.

12. The processed fish foodstuff of 11. wherein the other LAB is selected from the group consisting of Lactobacillus plantarum CCRC10069, Lactococcus lactis subsp. lactis CCRC 12315, and Lactobacillus helveticus CCRC 14092.

13. A processed fish foodstuff obtained by the method of 3.

14. A processed fish foodstuff obtained by the method of 3. and then sterilized at a temperature of from 95-115° C., shaped, and partly dried to a cheese-like product.

15. The processed fish foodstuff of 11., 12., 13., or 14. wherein the fish meat is at least one selected from the group consisting of red fish meat, white fish meat, frozen surimi and mixture thereof.

16. A method for processing legumes wherein LAB of 1. or 2. or other LAB or mixed strains thereof is (are) used in fermenting the legumes, comprising the steps of

homogenizing the legumes with water and filtering the resulting homogenate;

sterilizing the filtrate thus obtained at a temperature of from 100 to 115° C. for 15 to 30 minutes to obtain a substrate and then cooling the substrate to a temperature of from 25 to 40° C.;

adjusting the water content of the substrate by diluting it with water;

adding 1.0-6.0 wt % of a saccharide to the substrate and then inoculating the substrate with the LAB;

fermenting the substrate at a temperature of from 25-40° C. for 6-30 hours;

optionally adding a seasoning; and

optionally packaging the resulting product.

17. The method of 16. wherein the other LAB is selected from the group consisting of Lactobacillus plantarum CCRC10069, Lactococcus lactis subsp. lactis CCRC 12315, and Lactobacillus helveticus CCRC 14092.

18. The method of 16. wherein the legumes are at least one selected from the group consisting of soybean, black soybean and mixture thereof.

19. The method of 16. wherein the saccharide is at least one selected from the group consisting of sucrose, glucose and beet sugar.

20. The method of 16. wherein the water content of the substrate is in a range of from 50% to 98%.

21. The method of 16. wherein the seasoning is at least one selected from the group consisting of fresh fruits, processed fruits, sesame and peanuts.

22. The method of 16. wherein the substrate after fermenting has a pH value of from 4.5 to 6.0.

23. A processed legume foodstuff obtained from legumes fermented with LAB of 1. or 2. or other LAB or mixed strains thereof.

24. The processed legumes foodstuff of 23. wherein the other LAB is selected from the group consisting of Lactobacillus plantarum CCRC10069, Lactococcus lactis subsp. lactis CCRC 12315, and Lactobacillus helveticus CCRC 14092.

25. A processed legumes foodstuff obtained by the method of 16.

26. The processed legumes foodstuff of 23., 24., or 25. wherein the legumes are at least one selected from the group consisting of soybean, black soybean and mixture thereof.

27. A processed legumes foodstuff obtained by the method of 16. and then sterilized at a temperature of from 95-115° C., shaped, and partly dried to a cheese-like product.

28. A bacteriocin produced by the LAB of 1.

29. The bacteriocin of 28. which is an antibacterial substance having a molecular weigh of from 20 to 30 kDa.

30. A bacteriocin produced by the LAB of 2.

31. The bacteriocin of 30. which is an antibacterial substance having a molecular weigh of from 20 to 30 kDa.

### DETAILED DESCRIPTION OF THE INVENTION

The present invention is detailedly described as follows. The present invention provides two novel strains of lactic acid bacteria and bacteriocins obtained therefrom, a method for processing fish foodstuffs comprising using LAB and the products obtained thereby, and a method for processing legume foodstuffs comprising using LAB and the products obtained thereby.

Among the LAB used in the present invention, two novel strains Pediococcus pentosaceus YJL and YJS are isolated from meat. The genus Pediococcus is a group of Gram-negative bacteria having no motility and no productivity of spores and being catalase negative.

The present invention provides a method for processing fish meat wherein Pediococcus pentosaceus YJL or YJS or other LAB such as Lactobacillus plantarum CCRC10069, Lactococcus lactis subsp. lactis CCRC 12315, and Lactobacillus helveticus CCRC 14092, or mixed strains thereof is (are) used in fermenting the fish meat such as red fish meat, white fish meat, frozen surimi and mixture thereof, the method comprising the steps of

homogenizing the fish meat with the addition of sodium chloride in an amount of 0.3-2.0 wt % (based on the weight of the fish meat) and water in an amount 0.5-3 times the weight of the fish meat to obtain a homogenous substrate;

sterilizing the resulting substrate at a temperature of from 100 to 115° C. for 15 to 30 minutes and then cooling the same to a temperature of from 25 to 40° C.;

adjusting the water content of the substrate by diluting with water in a dilution ratio of 0-5 times;

adding 1.0-6.0 wt % of a saccharide such as sucrose, glucose and beet sugar to the substrate and then inoculating the substrate with the LAB;

fermenting the substrate at a temperature of from 25-40° C. for 6-30 hours to a final pH value of from 3.8-5.0;

optionally adding a seasoning, such as fresh fruits, processed fruits, sesame and peanuts, and a spice, such as ginger, garlic, mirin, wine, and prickly ash; and

optionally packaging the resulting product.

The present invention further provides a processed fish foodstuff obtained from fish meat such as red fish meat, white fish meat, frozen surimi and mixture thereof, fermented with Pediococcus pentosaceus YJL or YJS or other LAB such as Lactobacillus plantarum CCRC10069, Lactococcus lactis subsp. lactis CCRC 12315, and Lactobacillus helveticus CCRC 14092, or mixed strains thereof.

The present invention further provides a processed fish foodstuff obtained from fish meat such as red fish meat, white fish meat, frozen surimi and mixture thereof, fermented with Pediococcus pentosaceus YJL or YJS or other LAB such as Lactobacillus plantarum CCRC10069, Lactococcus lactis subsp. lactis CCRC 12315, and Lactobacillus helveticus CCRC 14092, or mixed strains thereof and then sterilized, shaped, and partly dried to a cheese-like product.

The present invention further provides a method for processing legumes wherein Pediococcus pentosaceus YJL or YJS or other LAB such as Lactobacillus plantarum CCRC10069, Lactococcus lactis subsp. lactis CCRC 12315, and Lactobacillus helveticus CCRC 14092, or mixed strains thereof is (are) used in fermenting the legumes, comprising the steps of

homogenizing the legumes such as soybean and black soybean, previously soaked in water, with the addition of water and filtering the resulting homogenate;

sterilizing the filtrate thus obtained at a temperature of from 100 to 115° C. for 15 to 30 minutes to obtain a substrate and then cooling the substrate to a temperature of from 25 to 40° C.; adjusting the water content of the substrate by diluting it with water to, for example, 50% to 98%;

adding 1.0-6.0 wt % of a saccharide such as sucrose, glucose and beet sugar to the substrate and then inoculating the substrate with the LAB;

fermenting at a temperature of from 25-40° C. for 6-30 hours;

optionally adding a seasoning, such as fresh fruits, processed fruits, sesame and peanuts; and

optionally packaging the resulting product.

The present invention further provides a processed legume foodstuff obtained from legumes such as soybean and black soybean, and mixture thereof, fermented with Pediococcus pentosaceus YJL or YJS or other LAB such as Lactobacillus plantarum CCRC10069, Lactococcus lactis subsp. lactis CCRC 12315, and Lactobacillus helveticus CCRC 14092, or mixed strains thereof.

The present invention further provides a processed legume foodstuff obtained from legumes such as soybean and black soybean, and mixture thereof, fermented with Pediococcus pentosaceus YJL or YJS or other LAB such as Lactobacillus plantarum CCRC10069, Lactococcus lactis subsp. lactis CCRC 12315, and Lactobacillus helveticus CCRC 14092, or mixed strains thereof and then sterilized, shaped, and partly dried to a cheese-like product.

The present invention further provides a bacteriocin produced from Pediococcus pentosaceus YJL, which is an antibacterial substance having a molecular weigh of from 20 to 30 kDa.

The present invention further provides a bacteriocin produced from Pediococcus pentosaceus YJS, which is an antibacterial substance having a molecular weigh of from 20 to 30 kDa.

### Preferred Embodiments

The present invention is further illustrated according to the preferred embodiments described below, however, the present invention is not limited to the details thereof.

Apparatus

Cryogenic shaking incubator: Orbital shaking incubator (HOTECH 718, Hotech Instruments Co., Taiwan)

High speed cryogenic centrifuge: Automatic high speed cryogenic centrifuge (SCR 20B, Hitachi, Japan)

Color measurement system: Model TC-1800MK-II, Tokyo Denshoku Co., Japan

pH meter: pH Meter (HM-30S, TOA Electronic Co., Japan)

Constant-temperature-humidity incubator: TC-120HD, Tungtec instruments C., LTD.

Grinding and emulsifying machine: UM-12, Stephan, Germany

Lyophilizer: Model FD-20-84, Fts ststems, INC., U.S.A.

Amino acid analyzer: Amino Acid Analyzer (Hitachi L-8500, Japan)

Rotavapor: Rotavapor (Bütchi RE111, Büchi, Switzerland)

Mini electrophoresis: Electrophoresis Cell (Mini-PROTEAN II, Bio-Rad, U. S. A.)

Power supply: Power Supply (Model 200/2.0, Bio-Rad, U.S. A.)

Homogenizer: Waring Blender (subjoined with a baffle, Japan)

Refrigerator: −30° C. and −80° C., Bio-Freezer (Model 8442, Form a Scientific, U.S.A.).

Colorimeter: Hitachi U-2001, Hitachi, Japan.

### EXAMPLE 1

Isolation and Identification of Pediococcus pentosaceus YJL and Pediococcus pentosaceus YJS

Isolation

Ten different cuts of raw pork meat were purchased from a local supermarket. Samples, 50 g, were weighed aseptically into sterile stomacher bags, sealed, and placed at 5° C. for up to 3 weeks. At weekly intervals, a sample was added to sterile 0.1% peptone to obtain a 1:10 dilution and placed in stomacher for 2 min. Serial dilutions were made in 0.1% peptone, spread plated onto MRS agar in quadruplicate, and incubated anaerobically at 37° C. for 48 to 72 h until growth was evident. Anaerobic incubation (GasPak; BBL) was used to rule out any inhibition due to hydrogen peroxide production. Three plates from the two dilutions having 30 to 300 CFU were overlaid with approximately 8 mL of brain heart infusion (BHI; Difco) which contained 1% agar. The overlay agar was seeded with L. monocytogenes CCRC 14845 at a level of 10⁵ to 10⁶ organisms per milliliter. A fourth plate from these dilutions was saved as a master control plate (no indicator overlay) for use in future replicate plating. The plates with the overlay were incubated anaerobically overnight at 37° C. Replica plates of those with inhibition zones were made from the master control plate onto Trypticase soy agar (without glucose) with a 2.0% yeast extract supplement (TSAYE). TSAYE plates were used to eliminate acid production due to glucose present in MRS. The indicator overlay was repeated. Colonies revealed inhibition zones were picked from master control plate with no indicator overlay into MRS broth incubated at 37° C.

Identification

1. Differentiation of Pediococci From Other Gram-Positive Bacteria:

Bacteriocin-producing meat isolates (isolates I and II) were incubated in MRSA broths for examining their physiological properties according to the protocol for differentiating Lactobacilli suggested by Schillinger, U.; Lucke, F. K. Identification of Lactobacillili from meat and meat products. Food Microbiol. 1987, 4, 199-208. The results were shown in Table 1.

TABLE 1
Physiological properties of P. pentosaceus YJL and
P. pentosaceus YJS

| | P. pentosaceus YJL | P. pentosaceus YJS |
|---|---|---|
| Determinations | (isolate I) | (isolate II) |
| Gram stain | + | + |
| Catalase test | −^{a} | − |
| Motility | − | − |
| Cellular morphology | cocci | cocci |
| Growth | | |
| 45° C. (2 days)^{c} | + | +^{b} |
| 40° C. (2 days) | + | + |
| 35° C. (2 days) | + | + |
| 30° C. (2 days) | + | + |
| 25° C. (3 days) | + | + |
| 20° C. (3 days) | + | + |
| 15° C. (7 days) | + | + |
| 4° C. (7 days) | + | − |
| Growth at initial pH | | |
| pH 4.0 (3 days) | + | + |
| pH 5.0 (3 days) | + | + |
| pH 6.0 (3 days) | + | + |
| pH 7.0 (3 days) | + | + |
| Growth at NaCl | | |
| concentration % | | |
| 0.0 (3 days) | + | + |
| 2.5 (3 days) | + | + |
| 4.0 (3 days) | + | + |
| 5.0 (3 days) | + | + |
| 10.0 (3 days) | − | + |
| 20.0 (3 days) | − | − |
| Final pH (3 days) | 3.99 | 3.91 |

Both strains were incubated in MRS broth.
^{a}“−” not grow or negative response
^{b}“+” grow or positive response
^{c}incubation time

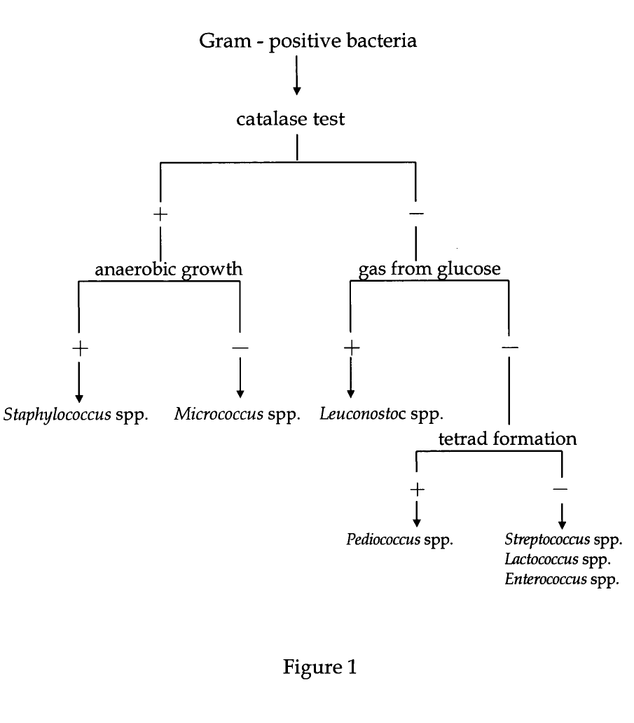

Based on the results in Table 1, the isolates I and II were identified as Pediococcus according to FIG. 1.

Further, from the results in Table 1, in particular, growth temperature, growth pH and resistance to NaCl, it was known that both isolates I and II are almost similar, except that the isolate I can grow at lower temperature (down to 4° C. for 7 days) and the isolate II show resistance to NaCl (10% NaCl for 3 days). Based on these results and the schemes for identifying species developed by Schillinger and Lücke (Food Microbiol. 1987, 4, 199-208), the isolates I and II are identified as Pediococcus pentosaceus.

2. API 50CHL System:

According to the identification API 50CHL system, the results were obtained as in Table 2. These two isolates are highly similar to P. pentosaceus CCRC 14024 (purchased from Food Industry Research and Development Institute, Hsinchu, Taiwan) except in the utilization of D-xylose, salicine and β-gentiobiose.

TABLE 2
Identification of P. pentosaceus YJL and P. pentosaceus YJS
with API 50CHL system

| | P. pentosaceus | P. pentosaceus YJL | P. pentosaceus |
|---|---|---|---|
| Carbohydrate | CCRC 14024 | (isolate I) | YJS (isolate II) |
| 2-ceto-gluconate | − | − | − |
| 5-ceto-gluconate | − | − | − |
| Adonitol | − | − | − |
| Amidon | − | − | − |
| Amygdaline | + | + | + |
| Arbutine | + | + | + |
| Cellobiose | + | + | + |
| D-Arabinose | − | − | − |
| D-Arabitol | − | − | − |
| D-Fructose | + | + | + |
| D-Fucose | − | − | − |
| D-Glucose | + | + | + |
| D-Lyxose | − | − | − |
| D-Mannose | + | + | + |
| D-Raffubose | + | + | + |
| D-Tagatose | + | + | + |
| D-Turanose | − | − | − |
| Dulcitol | − | − | − |
| D-Xylose | − | − | + |
| Erythritol | − | − | − |
| Esculin | + | + | + |
| Galactose | + | + | + |
| Gluconate | − | − | − |
| Glycerol | − | − | − |
| Glycogen | − | − | − |
| Inuline | − | − | − |
| L-Arabinose | + | + | + |
| Lactose | + | + | + |
| L-Arabitol | − | − | − |
| L-Fucose | − | − | − |
| L-Sorbose | − | − | − |
| L-Xylose | − | − | − |
| Maltose | + | + | + |
| Mannitol | − | − | − |
| Melezitose | − | − | − |
| Melibiose | + | + | + |
| N-Acetyl | + | + | + |
| glucosamine | | | |
| Rhamnose | + | + | + |
| Ribose | + | + | + |
| Saccharose | + | + | + |
| Salicine | − | + | + |
| Sorbitol | − | − | − |
| Trehalose | + | + | + |
| Xylitol | − | − | − |
| α-Methyl- | − | − | − |
| D-glycoside | | | |
| α-Methyl- | − | − | − |
| D-mannoside | | | |
| β-Gentiobiose | − | + | + |
| β-Methyl- | − | − | − |
| xyloside | | | |
| P. pentosaceus | 99.8 | 99.6 | 99.3 |
| ID (%) | | | |

all results were obtained from anaerobically incubation at 37° C. for 48 h
“+”: positive response
“−”: negative response

The results of P. pentosaceus CCRC 14024 showed an identification rate of 99.8% since for β-gentiobiose the negative result is opposite to the systemic value thereby caused an error.

The results of the Isolate I (Pediococcus pentosaceus YJL) showed an identification rate of 99.6% since for salicin and β-gentiobiose the negative results are opposite to the systemic values thereby causing an error.

The results of the Isolate II (Pediococcus pentosaceus YJS) showed an identification rate of 99.3% since for salicin and β-gentiobiose the negative results are opposite to the systemic values thereby causing an error.

Based on the conventional identification (item 1.) and API 50CHL system (item 2.), the isolates I and II are identified as Pediococcus pentosaceus and named, respectively, Pediococcus pentosaceus YJL and Pediococcus pentosaceus YJS.

3. Biochemical Test:

Pediococcus pentosaceus YJL and Pediococcus pentosaceus YJS both have hydrolysis ability on arginine and no utilization ability on urea, tetrazolium red and pyruvic acid. The morphology of the two strains was determined under Transmission Electron Microscopy (Hitachi, H-7000, Hitachi Co. Japan) to be tetrad without flagella.

4. Sensitivity to Antibiotics:

After adjusting the cell density in MRS broth to about 1.5×10⁸ CFU/mL, the cultures of isolates were streaked onto MRS agar plates and then the paper susceptibility discs with a diameter of 6 mm was stuck on. The resulting samples were then incubated at 37° C. for 12 h and then recorded the size of the inhibition zone. The antibiotics used in this study were all from BBL. The results were shown in Table 3.

TABLE 3
Antibiotic sensitivity of P. pentosaceus YJL and P. pentosaceus YJS

| Antibiotic | Conc.(mcg) | R^{a} | I^{a} | MS^{a} | S^{a} | P. pentosaceus YJL | P. pentosaceus YJS |
|---|---|---|---|---|---|---|---|
| Ampicillin | 10 | 21^{b} | | 22-29 | 30 | MS | MS |
| Cefotaxime | 30 | 14 | | 15-22 | 23 | MS | MS |
| Ceftazidime | 30 | 14 | | 15-22 | 23 | R | MS |
| Cefuroxime | 30 | 14 | | 15-22 | 23 | MS | S |
| Clindamycin | 2.0 | 14 | 15-16 | | 17 | S | S |
| Erythromycin | 15 | 13 | 14-17 | | 18 | S | S |
| Gentamicin | 10 | 12 | 13-14 | | 15 | I | R |
| Imipenem | 10 | | | | 16 | S | S |
| Moxalactam | 30 | 14 | | 15-22 | 23 | R | R |
| Nalidixic acid | 30 | 13 | 14-18 | | 19 | R | R |
| Netilmicin | 30 | 12 | 13-14 | | 15 | S | S |
| Penicillin | 10 | 19 | | 20-27 | 28 | MS | S |
| Tetracyclin | 30 | 14 | 15-18 | | 19 | S | I |
| Ticarcillin | 75 | 14 | | 15-19 | 20 | S | S |
| Vancomycin | 30 | 9 | 10-11 | | 12 | S | R |

^{a}R, resistant; I, intermediate; MS, moderately susceptible; S, susceptible ∘
^{b}diameter of inhibition zone (mm) ∘

As shown in Table 3, Pediococcus pentosaceus YJL is resistant to ceftazidime (30 mcg), moxalactam (30 mcg), and nalidixic acid (30 mcg); intermediate resistant to gentamicin (10 mcg); moderately susceptible to ampicillin (10 mcg), cefotaxime (30 mcg), cefuroxime (30 mcg), and penicillin (10 mcg); and susceptible to clindamycin (2 mcg), erythromycin (15 mcg), imipenem (10 mcg), moxalactam (30 mcg), netilmicin (30 mcg), tetracyclin (30 mcg), ticarcillin (75 mcg), and vancomycin (30 mcg).

Pediococcus pentosaceus YJS is resistant to gentamicin (10 mcg), moxalactam (30 mcg), nalidixic acid (30 mcg), and vancomycin (30 mcg); intermediate resistant to tetracyclin (30 mcg); moderately susceptible to cefotaxime (30 mcg) and ceftazidime (30 mcg); and susceptible to ampicillin (10 mcg), cefuroxime (30 mcg), clindamycin (2 mcg), erythromycin (15 mcg), imipenem (10 mcg), netilmicin (30 mcg), penicillin (10 mcg), and ticarcillin (75 mcg).

Based on the testing results shown above, the two strains were different in respect of physiological and biochemical properties. They were, therefore, denominated as Pediococcus pentosaceus YJL and Pediococcus pentosaceus YJS, respectively.

### EXAMPLE 2

Processed Fish Utilizing Lactobacillus plantarum CCRC10069, Lactococcus lactis subsp. lactis CCRC 12315, Lactobacillus helveticus CCRC 14092, Pediococcus pentosaceus YJL and P. pentosaceus YJS

Frozen mackerel (Scomber australasicus) was thawed in running tap water (about room temperature) and then gutted, eviscerated, deboned, and finally passed through a strainer (Meat Strainer, Model 5000, mesh: 0.3 cm, Chu-Hwa Co., Keelung, Taiwan) to remove the scale, pin bones, debris and connective tissues. The resulting samples were homogenized with equal volume of 2% NaCl solution and then diluted with water (2×), followed by sterilizing at 100° C. for 20 min and then cooled to 40° C. Finally, they were mixed with 4% sucrose, 1% glucose and LAB listed in Table 4 (inoculated to a final level of 10⁵ CFU/g) with stirring by a sterilized glass rod to obtain homogenous mixtures. The mixtures were fermented at 37° C. for 48 h. The changes in pH, viable counts of LAB, aerobic plate counts (APC) and volatile basic nitrogen (VBN) were measured. The Pseudomonas, Staphylococcus and Enterobacteriaceae, which were frequently detected on fresh or processed seafood and considered as main microflora, were also measured to evaluate the antimicrobial ability of these LAB. Also, sensory evaluation was carried out after the addition of mulberries and sugar to the fermented samples. The results were described below and shown in Tables 4 and 5.

At the end of fermentation, the pH of the five fermented samples with the addition of LAB was reduced from 6.2-6.3 to 4.5-4.7 while the pH of that without the addition of LAB was increased to 7.4-7.6. The VBN of samples without LAB increased rapidly from 8.2-8.6 to 50.2-51.4 mg/100 g after 24 h fermentation and further increased to 70.1-71.3 mg/100 g after 48 h fermentation, while those with LAB increased slowly from 8.1-8.6 to 21.0-24.8 mg/100 g. These data suggested that fermentation with LAB used in this study could substantially inhibit the accumulation of VBN. Also, the produced bacteriocins could inhibit the growth of saprogenic bacteria or pathogens such as Pseudomonas, Staphylococcus and Enterobacteriaceae. The Hunter L (indicator of transparency), b (indicator of yellow/blue) and whiteness of the five samples with LAB were significantly higher than that without LAB. Specifically, L increased from 47.61-49.98 to 59.03-65.06; b increased from 7.14-8.64 to 9.35-11.68; and whiteness increased from 46.8-49.3% to 57.9-63.5%. Further, as shown in Table 5, high acceptability on taste, flavor, texture and overall acceptance was obtained from the five samples with LAB. The sensory quality of the 24 h LAB-fermented samples seemed to be higher than that of 48 h LAB-fermented samples, though there was no significant difference between 24 h and 48 h fermented samples. It was also found that there was also no significant difference in sensory quality among samples fermented with different LAB.

TABLE 4
Changes in viable counts of aerobic bacteria, lactic acid bacteria, Enterobacteriaceae,
Staphylococcus and Pseudomonas of LAB
fermented mackerel minces fermented with 1 volume
of water (v/w) during 48 h fermentation at 37° C.

| | Ferment Time | Bacteria^{b} (log CFU/mL) | | | | |
|---|---|---|---|---|---|---|
| Starters* | (h) | APC | LAB | Entero. | Staph. | Pseudo. |
| NS | 0 | 4.20 ± 0.31^{e} | 3.34 ± 0.15^{c} | 2.78 ± 0.13^{b} | 2.97 ± 0.13^{c} | 4.10 ± 0.15^{c} |
| | 24 | 7.78 ± 0.36^{b} | 6.35 ± 0.32^{b} | 9.04 ± 0.27^{a} | 6.63 ± 0.23^{b} | 8.04 ± 0.26^{b} |
| | 48 | 8.17 ± 0.33^{a} | 7.24 ± 0.17^{a} | 9.08 ± 0.18^{a} | 7.54 ± 0.15^{a} | 9.04 ± 0.21^{a} |
| A | 0 | 6.23 ± 0.18^{b} | 6.40 ± 0.16^{b} | 3.15 ± 0.15^{c} | 2.77 ± 0.21^{c} | 3.22 ± 0.11^{b} |
| | 24 | 9.38 ± 0.33^{a} | 9.46 ± 0.19^{a} | 3.66 ± 0.21^{b} | 3.38 ± 0.22^{b} | 4.00 ± 0.26^{a} |
| | 48 | 9.27 ± 0.24^{a} | 9.49 ± 0.17^{a} | 4.10 ± 0.18^{a} | 4.13 ± 0.22^{a} | 4.20 ± 0.30^{a} |
| B | 0 | 6.28 ± 0.21^{c} | 6.34 ± 0.21^{c} | 3.08 ± 0.19^{e} | 3.10 ± 0.17^{b} | 3.31 ± 0.22^{b} |
| | 24 | 8.20 ± 0.32^{b} | 8.65 ± 0.17^{a} | 3.38 ± 0.13^{bc} | 3.20 ± 0.15^{b} | 3.52 ± 0.19^{b} |
| | 48 | 9.32 ± 0.32^{a} | 8.85 ± 0.21^{a} | 4.40 ± 0.23^{b} | 4.43 ± 0.18^{a} | 4.53 ± 0.20^{a} |
| C | 0 | 6.28 ± 0.20^{c} | 6.34 ± 0.21^{b} | 3.18 ± 0.19^{b} | 3.10 ± 0.17^{b} | 3.31 ± 0.21^{b} |
| | 24 | 8.20 ± 0.31^{b} | 8.65 ± 0.17^{a} | 3.38 ± 0.13^{b} | 3.20 ± 0.15^{b} | 3.32 ± 0.19^{b} |
| | 48 | 9.32 ± 0.35^{a} | 8.85 ± 0.22^{a} | 4.50 ± 0.24^{a} | 4.43 ± 0.19^{a} | 4.33 ± 0.20^{a} |
| D | 0 | 6.43 ± 0.19^{b} | 6.45 ± 0.12^{b} | 3.19 ± 0.11^{b} | 2.80 ± 0.25^{b} | 3.3 ± 0.14^{b} |
| | 24 | 9.36 ± 0.20^{a} | 9.26 ± 0.12^{a} | 3.95 ± 0.21^{a} | 3.00 ± 0.16^{b} | 3.49 ± 0.20^{b} |
| | 48 | 9.20 ± 0.27^{a} | 9.18 ± 0.20^{a} | 4.30 ± 0.15^{a} | 4.21 ± 0.20^{a} | 4.33 ± 0.17^{a} |
| E | 0 | 6.43 ± 0.19^{b} | 6.45 ± 0.12^{b} | 3.19 ± 0.11^{e} | 2.80 ± 0.25^{b} | 3.3 ± 0.14^{b} |
| | 24 | 9.36 ± 0.21^{a} | 9.26 ± 0.14^{a} | 3.95 ± 0.20^{b} | 3.00 ± 0.16^{b} | 3.09 ± 0.21^{b} |
| | 48 | 9.20 ± 0.31^{a} | 9.18 ± 0.21^{a} | 4.30 ± 0.14^{a} | 4.21 ± 0.20^{a} | 4.33 ± 0.19^{a} |

*NS: No starter added; A: Lactobacillus plantarum CCRC10069; B: Lactococcus lactis subsp. lactis CCRC12315; C: Lactobacillus helveticus CCRC14092; D: Pediococcus pentosaceus YJL; E: Pediococcus pentosaceus YJS.
^{b}Values in this Table are mean ± SD from 3 replicates; Values with unlike superscripts in the same colunm within each treatment differ significantly against fermentation time (p < 0.05).

TABLE 5
Sensory quality of the LAB fermented mackerel minces ground with 1
volume of water (v/w) during 48 h fermentation at 37° C.

| | | Incubation time (h) | | |
|---|---|---|---|---|
| Starter* | Evaluation items | 0 | 24 | 48 |
| NS | Taste | 4.1 ± 1.1^{a**} | —*** | — |
| | Flavor | 4.2 ± 1.2^{a} | — | — |
| | Texture | 3.3 ± 0.5^{a} | — | — |
| | Overall acceptance | 4.0 ± 0.5^{a} | — | — |
| A | Taste | 4.2 ± 1.1^{b} | 7.6 ± 1.2^{a} | 6.9 ± 1.0^{a} |
| | Flavor | 3.8 ± 1.2^{b} | 7.6 ± 1.1^{a} | 6.8 ± 0.8^{a} |
| | Texture | 3.3 ± 1.1^{b} | 8.2 ± 1.1^{a} | 7.1 ± 1.1^{a} |
| | Overall acceptance | 3.9 ± 1.0^{b} | 7.9 ± 0.8^{a} | 6.8 ± 0.7^{a} |
| B | Taste | 4.2 ± 1.2^{b} | 7.7 ± 1.2^{a} | 7.1 ± 1.1^{a} |
| | Flavor | 4.0 ± 1.1^{b} | 7.9 ± 1.0^{a} | 6.9 ± 0.9^{a} |
| | Texture | 3.4 ± 0.9^{b} | 8.3 ± 1.2^{a} | 7.2 ± 0.7^{a} |
| | Overall acceptance | 4.0 ± 1.2^{b} | 7.7 ± 1.2^{a} | 7.0 ± 1.0^{a} |
| C | Taste | 3.6 ± 0.7^{b} | 7.9 ± 0.9^{a} | 6.8 ± 1.2^{a} |
| | Flavor | 3.9 ± 1.0^{b} | 7.9 ± 1.1^{a} | 7.1 ± 1.1^{a} |
| | Texture | 3.7 ± 0.6^{b} | 8.3 ± 1.1^{a} | 7.3 ± 0.8^{a} |
| | Overall acceptance | 3.9 ± 1.0^{c} | 8.2 ± 1.1^{a} | 7.0 ± 1.3^{a} |
| D | Taste | 4.0 ± 1.0^{b} | 7.7 ± 0.7^{a} | 7.0 ± 1.3^{a} |
| | Flavor | 4.0 ± 0.8^{b} | 7.9 ± 1.1^{a} | 7.1 ± 1.2^{a} |
| | Texture | 3.7 ± 0.6^{b} | 8.4 ± 1.2^{a} | 7.4 ± 1.1^{a} |
| | Overall acceptance | 4.0 ± 1.1^{b} | 8.2 ± 1.1^{a} | 7.0 ± 1.1^{a} |
| E | Taste | 3.7 ± 1.0^{b} | 7.9 ± 0.9^{a} | 7.0 ± 1.1^{a} |
| | Flavor | 4.0 ± 0.8^{b} | 8.0 ± 1.1^{a} | 7.1 ± 1.2^{a} |
| | Texture | 3.9 ± 0.6^{b} | 8.2 ± 1.0^{a} | 7.2 ± 1.0^{a} |
| | Overall acceptance | 4.1 ± 1.1^{b} | 8.0 ± 1.1^{a} | 7.1 ± 1.2^{a} |

*Refer to the footnote of Table 4.
**Values in this Table are mean ± SD from 3 replicates; Values with unlike superscripts in the same column differ significantly (p < 0.05).
***spoiled.

### EXAMPLE 3

Processed Fish Cheese and Yogurt Utilizing Lactobacillus plantarum CCRC10069, Lactococcus lactis subsp. lactis CCRC 12315, Lactobacillus helveticus CCRC 14092, Pediococcus pentosaceus YTL and P. pentosaceus YTS

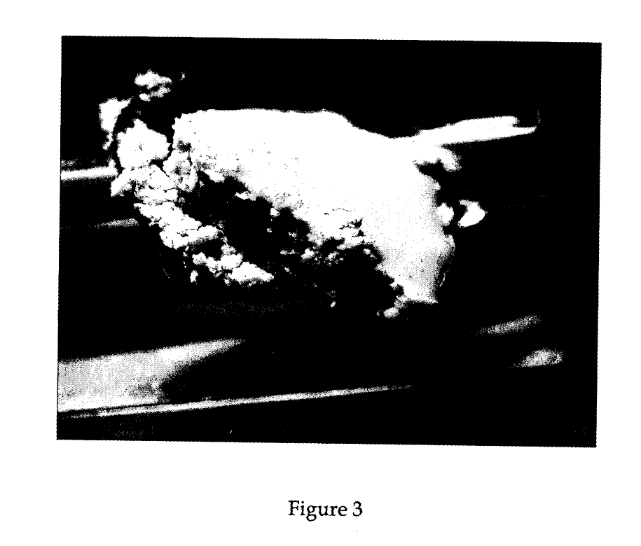

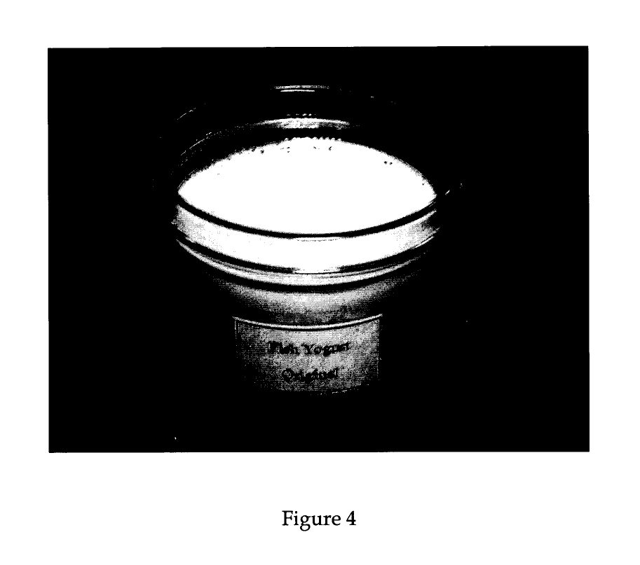

Frozen nemipterid surimi was thawed at 5° C. overnight. The surimi was homogenized with equal volume of 1.0% NaCl solution and then sterilized at 100° C. for 15 min and cooled to 30° C. Finally, the homogenate was mixed with 4% sucrose and LAB (inoculated to a final level of 10⁵ CFU/g) with stirring by a sterilized glass rod to obtain homogenous mixtures. The mixtures were fermented at 37° C. for 24 h. The sensory evaluation was carried out after the addition of sesame or peanut powder to the fermented samples, sterilization at 100° C. for 15 min and shaping to a rectangle form. The resulting fish cheese was shown in FIG. 3. In the similar way, one sample was processed to a yogurt-like product as shown in FIG. 4.

The results were described below. The pH of five fermented samples with the addition of LAB was reduced to 4.6-4.8. High acceptability on taste, flavor, texture and overall acceptance was obtained from the five samples with LAB.

### EXAMPLE 4

Processed Legume Utilizing Pediococcus pentosaceus YJL and P. pentosaceus YJS

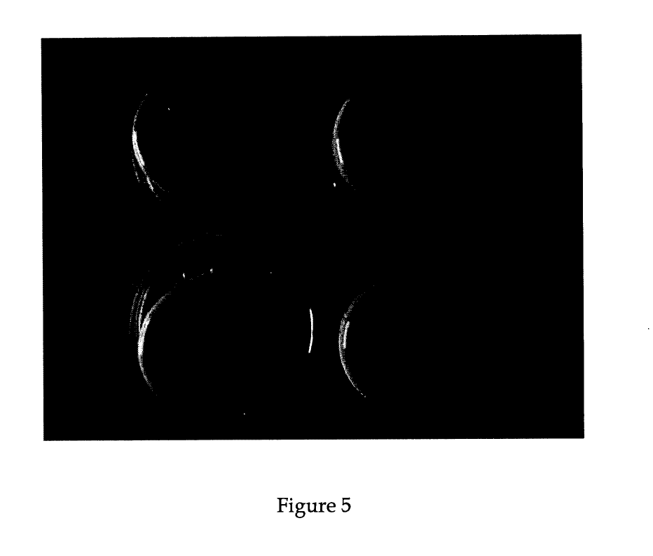

Soaked soybean was homogenized with water, filtered and sterilized at 100° C. for 20 min and then cooled to 30° C. The water content was adjusted to 60%. Finally, the homogenate was mixed with 4% sucrose, 1% glucose and LAB (inoculated to a final level of 10⁵ CFU/g) with stirring by a sterilized glass rod to obtain homogenous mixtures. The mixtures were fermented at 37° C. for 24 h. The changes in pH, viable counts of LAB, aerobic plate counts (APC) were measured. The Pseudomonas, Staphylococcus and Enterobacteriacea were also measured. Also, sensory evaluation was carried out after the addition of strawberries and sugar to the fermented samples. The results were described below and shown in Tables 6 and 7. Further, one sample was processed to a pudding-like product as shown in FIG. 5.

At the end of fermentation, the pH of the two fermented samples with the addition of LAB was reduced from 6.0-6.2 to 4.7-4.9 while the pH of that without the addition of LAB was increased to 7.5-7.7. The growth of Pseudomonas, Staphylococcus and Enterobacteriaceae is all inhibited effectively (Table 6). The Hunter L, b and whiteness of the two samples with LAB were significantly higher than that without LAB (p<0.05). Further, as shown in Table 7, high acceptability on taste, flavor, texture and overall acceptance was obtained from the two samples with LAB.

TABLE 6
Changes in viable counts of aerobic bacteria, lactic acid bacteria,
Enterobacteriaceae, Staphylococcus and Pseudomonas of LAB
fermented soybean after 24 h fermentation at 37° C.

| | Ferment Time | Bacteria^{b} (log CFU/mL) | | | | |
|---|---|---|---|---|---|---|
| Starters* | (h) | APC | LAB | Entero. | Staph. | Pseudo. |
| NS | 0 | 4.20 ± 0.31^{e} | 3.34 ± 0.15^{c} | 2.78 ± 0.13^{b} | 2.97 ± 0.13^{c} | 4.10 ± 0.15^{c} |
| | 24 | 7.79 ± 0.37^{b} | 6.33 ± 0.33^{b} | 9.14 ± 0.27^{a} | 6.73 ± 0.23^{b} | 8.10 ± 0.26^{b} |
| A | 0 | 6.43 ± 0.19^{b} | 6.45 ± 0.12^{b} | 3.19 ± 0.11^{b} | 2.80 ± 0.25^{b} | 3.3 ± 0.14^{b} |
| | 24 | 9.37 ± 0.20^{a} | 9.29 ± 0.12^{a} | 3.55 ± 0.21^{a} | 3.10 ± 0.16^{b} | 3.29 ± 0.20^{b} |
| B | 0 | 6.23 ± 0.19^{b} | 6.35 ± 0.12^{b} | 3.09 ± 0.11^{e} | 2.90 ± 0.25^{b} | 3.20 ± 0.14^{b} |
| | 24 | 9.32 ± 0.21^{a} | 9.28 ± 0.14^{a} | 3.45 ± 0.21^{b} | 3.05 ± 0.11^{b} | 3.09 ± 0.20^{b} |

*NS: No starter added; A: Pediococcus pentosaceus YJL; B: Pediococcus pentosaceus YJS.
^{b}Values in this Table are mean ± SD from 3 replicates; Values with unlike superscripts in the same column within each treatment differ significantly against fermentation time (p < 0.05).

TABLE 7
Sensory quality of the LAB fermented soybean after
24 h fermentation at 37° C.

| Starter | Evaluation Items | 0 | 24 |
|---|---|---|---|
| NS | Taste | 4.1 ± 1.1^{a}** | 4.0 ± 1.3^{a}** |
| | Flavor | 4.2 ± 1.2^{a} | 4.1 ± 1.5^{a} |
| | Overall acceptance | 4.0 ± 0.5^{a} | 4.0 ± 0.8^{a} |
| A | Taste | 4.3 ± 1.1^{a}** | 7.6 ± 1.2^{a} |
| | Flavor | 4.0 ± 1.2^{a} | 7.6 ± 1.1^{a} |
| | Overall acceptance | 4.0 ± 0.7^{a} | 7.9 ± 0.8^{a} |
| B | Taste | 4.2 ± 1.1^{a}** | 7.7 ± 1.2^{a} |
| | Flavor | 4.2 ± 1.4^{a} | 7.9 ± 1.0^{a} |
| | Overall acceptance | 4.1 ± 0.6^{a} | 7.7 ± 1.2^{a} |

*Refer to the footnote of Table 6.
**Values in this Table are mean ± SD from 3 replicates; Values with unlike superscripts in the same column differ significantly (p < 0.05).

### EXAMPLE 5

Isolation and Identification of Bacteriocins from Pediococcus pentosaceus YJL and P. pentosaceus YJS

1. Isolation of Bacteriocins:

After 48 h incubation at 37° C., the MRS broth was centrifuged at 5,000×g, 25° C. for 30 min and then filtered through a membrane (0.45 μm, No. 4654, Gelman) to remove the cells. The filtrates were further washed with 2 volumes of sterile distilled water and concentrated to about 30 mL using Amicon ultrafiltration (cutoff: 1,000, 180 mL, Model 8400). The L. monocytogenes CCRC 14845 was employed to detect the inhibition ability of the purified bacteriocins. The concentrated fractions were adjusted to pH 6.0 and used as crude bacteriocins for the further purification. The filtrates after Amicon ultrafiltration had no inhibition ability against L. monocytogenes CCRC 14845.

2. Chloroform Extraction:

400 mL of MRS broth was inoculated with 0.1% of an overnight culture of Pediococcus pentosaceus YJL and Pediococcus pentosaceus YJS and incubated for 18 h at 37° C. The culture was centrifuged at 9,500 g for 15 min (4° C.) and the bacteriocin-containing supernatant was filtrated through a 0.45 μm filter. The filtrate was stirred vigorously using a magnetic stirrer for 20 min with 400 mL of chloroform. The mixture was then centrifuged at 10,400 g, 4° C. for 20 min. Four phases were observed in chloroform-containing mixture. The solvent-aqueous interface layer which had high antibacterial activity was collected and dissolved in 5-10 mL buffer (0.1 M Tris-HCl, pH 7.0), since there was no activity in aqueous phase, solvent phase and precipitates. The bacteriocin-containing buffer was concentrated with vacuum evaporator (40° C.) (Rotavapor R114, BÜCHI) to remove the residual chloroform. The final volume of the concentrated bacteriocin was 2-3 mL (Burianek and Yousef, 2000). The bacteriocins were named Pediocin L and Pediocin S, respectively.

3. Sodium dodecyl sulfate polyacrylamide gel electrophoresis (SDS-PAGE):

To confirm the purity of purified bacteriocin and to determine its molecular weight, purified bacteriocins in a dissociating buffer (62.5 mM Tris-HCl buffer, pH 6.8, containing 3% SDS and 0.002% bromophenol blue) was heated in a water-bath at 100° C. for 5 min. The purity of the purified bacteriocins was determined using 8-15% gradient polyacrylamide SDS-PAGE, while the MW was determined by 15% SDS-PAGE according to Laemmli (1970). After electrophoresis, the gel plate was immobilized with 15% TCA, stained with Coomassie brilliant blue G-250, and destained with 25% methanol. Finally, the gel plate was dried in cellophane paper.

4. Protein Concentration:

Protein concentrations of purified bacteriocins during purification were determined by a dye-binding method of Bradford (1976). Bovine serum albumin was used as a standard protein.

5. Inhibition Assay

The agar diffusion method was used to assay the inhibition ability of bacteriocins according to Piddock (1990). The broth was inoculated with indicator organisms (Table 8) and incubated at 37° C. for 24 h. After adjusting the level of cells in broth to about 1.5×10⁸ CFU/mL, approximate 0.1 mL of indicator broth was mixed uniformly with 15 mL of warm agar. The agar was poured into petridish and stood at 5° C. for 1 h. After punching the agar using a stainless ring with a diameter of 6 mm, approximate 25 μL of samples were added into the hole and incubated at 5° C. for 24 h to allow the bacteriocins diffusion. The resulting samples were then incubated at 37° C. for 6 h and then the size of inhibition zone was recorded to qualifying the inhibition ability.

6. Biochemical Properties

6.1 Sensitivity of Bacteriocin to the Proteolytic Enzymes:

After adjusting the pH of the purified bacteriocins to 4.0, 5.0, 6.0, 7.0 and 8.0 using 1.0 N HCl or 1.0 N NaOH, proteases were added and incubated at 37° C. for 2 h. The reaction was stopped by heating at 80° C. water bath for 15 min. After cooling to room temperature, the inhibition ability of resulted bacteriocins was determined according to Piddock (1990). Proteases used in this study included pepsin (from Porcine Stomach Mucosa, Sigma), α-chymotrypsin (from Bovine Pancreas, Sigma), pronase (from Streptomyces griseus, Sigma) and bromelain (from Pineapple stem, Sigma).

6.2 Thermostability of Purified Bacteriocins

After adjusting the pH of purified bacteriocins to 4.0, 5.0, 6.0, 7.0 and 8.0 using 1.0 N HCl or 1.0 N NaOH, the resulted samples were incubated at 80° C. or 100° C. for 15, 30, 45 and 60 min or 121° C. for 15 min. They were cooled down to room temperature and the inhibition ability was determined according to Piddock (ibid).

6.3 Bacteriocin Spectrum of Activity

Pentocin YJL and Pentocin YJS were screened for activity against a pathogen panel and spoilage bacteria as shown in Table 8.

TABLE 8
The cultivation conditions of tested strains for inhibition spectrum
experiment

| | Culture medium/ | |
|---|---|---|
| Organism | Temp.^{a} | Source |
| Alcaligenes faecalis ATCC 8750 | NA/37° C. | CCRC^{b} |
| Aeromonas faecalis | NA/37° C. | Prof. Tsai^{c} |
| Bacillus circulans ATCC 11059 | NA/37° C. | CCRC |
| Bacillus subtilis ATCC 10225 | NA/37° C. | CCRC |
| Bacillus subtilis ATCC 10254 | NA/37° C. | CCRC |
| Bacillus cereus ATCC 11778 | NA/37° C. | CCRC |
| Clostridium sporogenous ATCC 11259 | TSB/37° C. | CCRC |
| Enterobacter aerogenes ATCC 13048 | NA/37° C. | CCRC |
| Escherichia coli ATCC 11229 | NA/37° C. | CCRC |
| Escherichia coli ATCC 11303 | NA + 0.5% NaCl/ | CCRC |
| | 37° C. | |
| Klebsiella oxytoca ATCC 13182 | NA/37° C. | CCRC |
| Listeria monocytogenes RII | TSBYE/37° C. | NLFD^{d} |
| Listeria monocytogenes LM | TSBYE/37° C. | NLFD |
| Listeria monocytogenes CCRC 14845 | TSBYE/37° C. | CCRC |
| Pseudomonas fluorescens ATCC 13523 | NA/26° C. | CCRC |
| Proteus vulgaris ATCC 13315 | NA/37° C. | CCRC |
| Staphylococcus aureus ATCC 25923 | TSA/37° C. | CCRC |
| Staphylococcus epidermidis ATCC 14990 | NA/37° C. | CCRC |
| Streptococcus faecalis DS-5 | MRS/37° C. | CCRC |
| Shigella dysenteriae ATCC 13983 | NA/37° C. | CCRC |
| Vibrio cholerae | NA + 0.5% NaCl/ | CCRC |
| | 26° C. | |

^{a}Incubation time: 24 h.
^{b}CCRC: Culture Collection and Research Center, Food Industry Research and Development Institute, Hsinchu, Taiwan.
^{c}Lab of Prof. Tsai, Dept. Food Sci., National Taiwan Ocean University, Taiwan.
^{d}NLFD: National Laboratories of Foods and Drugs, Development of Health, Executive Yuan, Taiwan.

7. Result

7.1 Purification of Bacteriocins From Pediococcus pentosaceus YJL and P. pentosaceus YJS

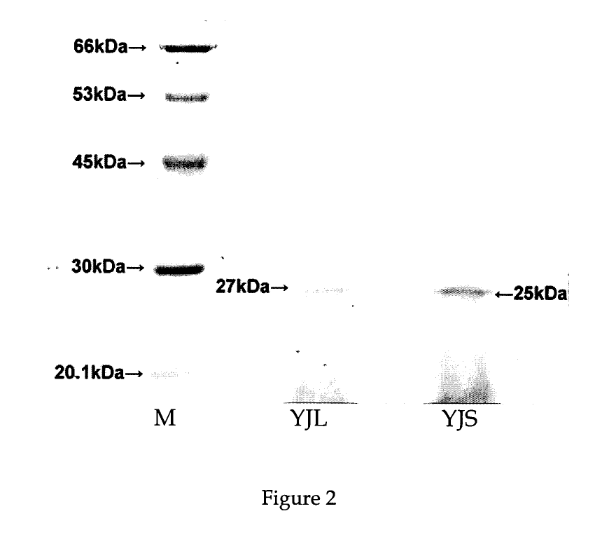

According to the results from ultra-filtration and SDS-PAGE electrophoresis (FIG. 2) and the indication of no activity in proteolytic enzymes test, it was known that pentocins YJL and YJS are proteins and have a molecular weight of 27 and 25 kDa, respectively. They were very stable at temperatures below 80° C., pH 4.0-8.0. There was more than 80% activity left even after 30 min heating at 80° C., pH 4.0-8.0 for pentocin YJL, and pH 4.0-6.0 for pentocin YJS. About 41% and 37% activity of pentocin YJS were left even after 30 min heating at 100° C., pH 4.0 and 5.0, respectively, and 34% activity of pentocin YJL was left after 30 min heating at 100° C., pH 4.0. This phenomenon suggested the potential of these bacteriocins for using in preservation of foods.

7.2 Bacteriocin Spectrum of Activity

The spectrum of antimicrobial activity of the pentocins YJL and YJS is shown in Table 9. As shown in the Table, pentocin YJL inhibited the growth of gram-negative strains including Shigella, E. aerogenes, P. vulgaris, S. dysenteriae, and V. cholerae, and gram-positive strains including B. subtilis, B. cereus, B. circulans, L. monocytogenes, and S. epidermidis. Pentocin YJS inhibited the growth of gram-negative strains including Shigella, K. oxytoca, and V. cholerae, and gram-positive strains including B. subtilis, B. cereus, B. circulans, and L. monocytogenes. This result indicated that the two pentocins are broad-spectrum bacteriocins.

TABLE 9
Antibacterial spectrum of Pentocins YJL and YJS

| Organism | Pentocin YJL | Pentocin YJS |
|---|---|---|
| G (−) | | |
| Alcaligenes faecalis ATCC 8750 | −* | − |
| Aeromonas faecalis | − | − |
| Enterobacter aerogenes ATCC 13048 | + | − |
| Escherichia coli ATCC 11229 | − | − |
| Escherichia coli ATCC 11303 | + | − |
| Klebsiella oxytoca ATCC 13182 | + | + |
| Pseudomonas fluorescens ATCC 13523 | − | − |
| Proteus vulgaris ATCC 13315 | + | + |
| Shigella dysenteriae ATCC 13983 | + | + |
| Vibrio cholerae | + | + |
| G (+) | | |
| Listeria monocytogenes Ram II | + | + |
| Listeria monocytogenes LM | + | + |
| Listeria monocytogenes CCRC 14845 | + | + |
| Staphylococcus aureus ATCC 25923 | − | − |
| Staphylococcus epidermidis | + | − |
| ATCC 14990 | | |
| Streptococcus faecalis DS-5 | − | − |
| Spore-forming bacteria | | |
| Bacillus circulans ATCC 11059 | + | + |
| Bacillus subtilis ATCC 10225 | + | + |
| Bacillus subtilis ATCC 10254 | + | + |
| Bacillus cereus ATCC 11778 | + | + |
| Clostridium sporogenous ATCC 11259 | + | + |

*a: “−” inhibition zone < 6 mm; b: “+” inhibition zone > 6 mm.

7.3 Inhibition of the Germination and Growth of Spore-Forming Bacteria

As shown in Table 9, pentocins YJL and YJS inhibited the growth of Bacillu and Clostridium. According, a further study was carried out on Bacillus subtilis ATCC 10225, B. subtilis ATCC 10254 and B. cereus ATCC 11778 and the result was shown in Table 10. It is found that the two pentocins effectively inhibited the germination of spores. For pentocin YJL, the inhibition zones in the spore-forming bacteria Bacillus subtilis ATCC 10225, B. subtilis ATCC 10254 and B. cereus ATCC 11778 were 120.3, 174.3 and 236.3 mm², respectively, and in the spores were 64.0, 96.3 and 189.0 mm². For pentocin YJS, the inhibition zones in the spore-forming bacteria were 189.0, 146.3 and 236.3 mm², respectively, and in the spores were 85.0, 108.0 and 189.0 mm². It is therefore concluded that both pentocins YJL and YJS had maximum inhibition zone in B. cereus and its spore, namely, up to 236.3 and 189.0 mm², respectively. Further, both pentocins had more inhibition activity on the spore-forming bacteria than on their spores.

TABLE 10
Effect of Pentocins YJL and YJS on the growth of bacterial
vegetative cell and spores

Inhibition zone (mm²)

| Bacterium | Pentocin YJL | Pentocin YJS |
|---|---|---|
| Bacillus subtilis ATCC 10225 | | |
| vegetative cell | 120.3 | 189.0 |
| spore | 64.0 | 85.0 |
| B. subtilis ATCC 10254 | | |
| vegetative cell | 174.3 | 146.3 |
| spore | 96.3 | 108.0 |
| B. cereus ATCC 11778 | | |
| vegetative cell | 236.3 | 236.3 |
| spore | 189.0 | 189.0 |

The present invention is not limited to the preferred embodiments described above, any modification and variation to the invention without departing from the spirit of the invention is well known to people skilled in this art.

### INDUSTRIAL APPLICABILITY

The present invention provides two novel strains of lactic acid bacteria (LAB) and bacteriocins thereof, a method for processing fish foodstuffs comprising using LAB and the products obtained, and a method for processing legume foodstuffs comprising using LAB and the products obtained. Specifically, the present invention provides novel LAB isolated from meat useful in the methods for processing fermented foodstuffs wherein fish or legume is used as raw material. Also, the present invention provides processed products with reduced growth of unwanted microorganisms, improved flavor and enhanced economic value. The present invention further provides bacteriocins obtained from the novel LAB. The bacteriocins are effective on the inhibition of unwanted microorganisms thereby insure the foodstuff a good quality during storage.

### REFERENCE

Acton J C, Dick R L, Norris E L. 1977. Utilization of various carbohydrates in fermented sausage. J. Food Sci. 42: 174-178.

Bacus J N, Brown W L. 1981. Use of microbial cultures: Meat products. Food Technol. 35(1): 74-78.

Bhunia A K, Johnson M C, Ray B, Kalchayanand N. 1991. Mode of action of pediocin AcH from Pediococcus acidilactici H on sensitive bacterial strains. J. Appl. Bacteriol. 70: 25-33.

Bhunia A K, Johnson M C, Ray B. 1988. Purification, characterization and antimicrobial spectrum of a bacteriocin produced by Pediococcus acidilacitci. J. Appl. Bacteriol. 65: 261-268.

Bradford M M. 1976. A rapid and sensitive method for the quantitation of microgram quantities of protein utilizing the principal of protein-dye binding. Analyt. Biochem. 72: 248-254.

Burianek L L, Yousef A E. 2000. Solvent extraction of bacteriocins from liquid cultures. Lett. Applied Microbiol. 31: 193-197.

Choi S Y, Beuchat L R. 1994. Growth inhibition of Listeria monocytogenes by a bacteriocin of Pediococcus acidilactici M during fermentation of kimchi. Food Microbiol. 11: 301-307.

Cutter C N, Siragusa G R. 1996. Reduction of Listeria innocua and Brochothrix thermosphacta on beef following nisin spray treatments and vacuum packaging. Food Microbiol. 13(1): 23-33.

Daeschel M A, Klaenhammer T R. 1985. Association of a 13.6-megadalton plasmid in Pediococcus pentosaceus with bacteriocin activity. Appl. Environ. Microbiol. 50: 1538-1541.

Daeschel M A. 1989. Antimicrobial substances from lactic acid bacteria for use as food preservatives. Food Technol. 43: 164-167.

Deklerk H C, Smit J A. 1967. Properties of a Lactobacillus fermentum bacteriocin. J. Gen. Microbiol. 48: 309-314.

Gibbs P A. 1987. Novel uses of lactic acid fermentation in food preservation. J. Appl. Bacteriol. Sym. Suppl. 51S-58S.

Harnulv B G, Kandasamy C. 1982. Increasing the keeping quality of raw milk by activation of the lactoperoxidase system. Results from Sri Lanka. Milchwissenschaft. 37: 454-461.

Helander I M, von Wright A, Mattila-Sandholm T M. 1997. Potential of lactic acid bacteria and novel antimicrobials against gram-negative bacteria. Trends Food Sci. Technol. 8(5): 146-150.

Jay J M. 1982. Antimicrobial properties of diacetyl. Appl. Environ. Microbiol. 44:525.

Joerger M C, Klaenhammer T R. 1986. Characterization and purification of helveticin J and evidence for a chromosomally determined bacteriocin produced by Lactobacillus helveticus 481. J. Bacteriol. 167: 439.

Kandler O. 1983. Carbohydrate metabolism in lactic acid bacteria. Antonie Vam Leeuwenhoek 49: 209-213.

Klaenhammer T R. 1988. Bacteriocins of lactic acid bacteria. Biochimie 70: 337-349.

Laemmli U K. 1970. Cleavage of structural proteins during the assembly of the head bacteriophage T4. Nature 277(4): 680-685.

Monnet C, Davies C, Schmitt P. 1994. Diacetyl production in milk by and α-acetolactic acid accumulating strain of Lactococcus lactis spp. Lactis biovar. Diacetylactis. J. Dairy Sci. 77: 2916-2924.

Motlagh A M, Holla S, Johnson M C, Ray B, Field R A. 1992. Inhibition of Listeria spp. In sterile food system by pediocin AcH, a bacteriocin produced by Pediococcus acidilactici H. J. Food Prot. 55(5): 337-343.

Muriana P M, Klaenhammer T R. 1987. Conjugal transfer of plasmid-encoded determinants for bacteriocin production and immunity in Lactobacillus acidophilus 88. Appl. Environ. Microbiol. 53: 553-561.

Nielsen J W, Dickson J S, Crouse J D. 1990. Use of a bacteriocin produced by Pediococcus acidilactici to inhibit Listeria monocytogenes associated with fresh meat. Appl. Environ. Microbiol. 56(7): 2142-2145.

Oda M, Hasegawa H, Komatsu S, Kambe M, Tsuchiya F. 1983. Anti-tumor polysaccharide from Lactobacillus spp. Agric. Biol. Chem. 47(7): 1623-1625.

Okereke A, Montville T J. 1991. Bacteriocin-mediated inhibition of Clostridium botulinum spores by lactic acid bacteria at refrigeration abuse temperatures. Appl. Environ. Microbiol. 57 (12): 3423-3428.

Parente E, Ricciardi A, Moles M. 1996. Leucocin F10, a bacteriocin from Leuconostoc carnosum. International J. Food Microbiol. 33: 231-243.

Piddock L J V. 1990. Techniques used for the determination of antimicrobial resistance and sensitivity in bacteria. J. Appl. Bacteriol. 68: 307-318.

Roller S, Lusengo J. 1997. Developments in natural food preservatives. Agro Food Industry Hi Tech 7: 22-25.

Scbillinger U, Holzapfel W H. 1996. Guideline for manuscripts on bacteriocins of lactic acid bacteria. International J. Food Microbiol. 33:3-5.

Schillinger U, Lücke F K. 1987. Identification of Lactobacilli from meat and meat products. Food Microbiol. 4: 199-208.

Schillinger U, Lucke F K. 1989. Antibacterial activity of Lactobacillus sake isolated from meat. Appl. Environ. Microbiol. 55(8): 1901-1906.

Sedewitz B, Schleifer K H, Gotz F. 1983. Purification and properties of pyruvate oxidase from Lactobacillus plantarum in lactic acid bacteria in foods. Proc. Neth. Soc. Microbial. Mtg., Wageningen. The Netherlands. Sept.

Siddons R C, Coates M E. 1985. The influence of the intestinal microflora on disaccharidase activities in the duck. Br. J. Nutr. 27: 101-112.

Spelhaug S R, Harlander S K. 1989. Inhibition of foodborne bacterial pathogens by bacteriocins from Lactobacillus lactis and Pediococcus pentosaceus. J. Food Prot. 52(12): 856-862.

Vignolo G, Kairuz M V, Oliver G, Fadda S. 1996. Control of Listeria monocytogenes in ground beef by “Lactocin 705”, a bacteriocin produced by Lactobacillus casei CRL 705. International J. Food Microbiol. 19: 397-402.

West C A, Warner P J. 1988. Plantacin B, a bacteriocin produced by Lactobacillus plantarum NCOD 1193. FEMS Microbiol. Lett. 49: 163-169.

What is claimed is:

1. Pediococcus pentosaceus YJL with the accession numbers FERM-BP 8450 (BCRC 910210).

2. Pediococcus pentosaceus YJS with the accession numbers FERM-BP 8449 (BCRC 910211).

3. A method for processing fish meat wherein Pediococcus pentosaceus according to claim 1 or 2 or other LAB or mixed strains thereof is (are) used in fermenting the fish meat, comprising the steps of
homogenizing the fish meat with the addition of sodium chloride in an amount of 0.3 to 2.0 wt % (based on the weight of the fish meat) and water in an amount of 0.5 to 3 times of the weight of the fish meat to obtain a homogenous substrate;
sterilizing the resulting homogenous substrate at a temperature of from 100 to 115° C. for 15 to 30 minutes and then cooling the same to a temperature of from 25 to 40° C.;
adjusting the water content of the substrate by diluting it with water in a dilution ratio of 0 to 5 times;
adding 1.0 to 6.0 wt % of a saccharide to the substrate and then inoculating the substrate with the LAB;
fermenting the substrate inoculated with the LAB at a temperature of from 25 to 40° C. for 6 to 30 hours;
optionally adding a seasoning and a spice; and
optionally packaging the resulting product.

4. The method according to claim 3 wherein the other LAB is selected from the group consisting of Lactobacillus plantarum CCRC10069, Lactococcus lactis subsp. lactis CCRC 12315, and Lactobacillus helveticus CCRC 14092.

5. The method according to claim 3 wherein the fish meat is at least one selected from the group consisting of red fish meat, white fish meat, frozen surimi and mixture thereof.

6. The method according to claim 3 wherein the saccharide is at least one selected from the group consisting of sucrose, glucose and beet sugar.

7. The method according to claim 3 wherein the substrate is a non-diluted or 5-fold-diluted surimi.

8. The method according to claim 3 wherein the seasoning is at least one selected from the group consisting of fresh fruits, processed fruits, sesame and peanuts.

9. The method according to claim 3 wherein the spice is at least one selected from the group consisting of ginger, garlic, mirin, wine, and prickly ash.

10. The method according to claim 3 wherein the substrate after fermenting has a pH value of from 3.8 to 5.5.

11. A processed fish foodstuff obtained from fish meat fermented with Pediococcus pentosaceus according to claim 1 or 2 or other LAB or mixed strains thereof.

12. The processed fish foodstuff according to claim 11 wherein the other LAB is selected from the group consisting of Lactobacillus plantarum CCRC10069, Lactococcus lactis subsp. lactis CCRC 12315, and Lactobacillus helveticus CCRC 14092.

13. A processed fish foodstuff obtained by the method according to claim 3.

14. A processed fish foodstuff obtained by the method according to claim 3 and then sterilized at a temperature of from 95 to 115° C., shaped, and partly dried to a cheese-like product.

15. The processed fish foodstuff according to claim 11 wherein the fish meat is at least one selected from the group consisting of red fish meat, white fish meat, frozen surimi and mixture thereof.

16. The processed fish foodstuff according to claim 13 wherein the fish meat is at least one selected from the group consisting of red fish meat, white fish meat, frozen surimi and mixture thereof.

17. A method for processing legumes wherein Pediococcus pentosaceus according to claim 1 or 2 or other LAB or mixed strains thereof is (are) used in fermenting the legumes, comprising the steps of
homogenizing the legumes with water and filtering the resulting homogenate;
sterilizing the filtrate thus obtained homogenate at a temperature of from 100 to 115° C. for 15 to 30 minutes to obtain a substrate and then cooling the substrate to a temperature of from 25 to 40° C.;
adjusting the water content of the substrate by diluting it with water;
adding 1.0 to 6.0 wt % of a saccharide to the substrate and then inoculating the substrate with the LAB;
fermenting the substrate inoculated with the LAB at a temperature of from 25 to 40° C. for 6 to 30 hours;
optionally adding a seasoning; and
optionally packaging the resulting product.

18. The method according to claim 17 wherein the other LAB is selected from the group consisting of Lactobacillus plantarum CCRC10069, Lactococcus lactis subsp. lactis CCRC 12315, and Lactobacillus helveticus CCRC 14092.

19. The method according to claim 17 wherein the legumes are at least one selected from the group consisting of soybean, black soybean and mixture thereof.

20. The method according to claim 17 wherein the saccharide is at least one selected from the group consisting of sucrose, glucose and beet sugar.

21. The method according to claim 17 wherein the water content of the substrate is in a range of from 50% to 98%.

22. The method according to claim 17 wherein the seasoning is at least one selected from the group consisting of fresh fruits, processed fruits, sesame and peanuts.

23. The method according to claim 17 wherein the substrate after fermenting has a pH value of from 4.5 to 6.0.

24. A processed legume foodstuff obtained from legumes fermented with Pediococcus pentosaceus according to claim 1 or 2 or other LAB or mixed strains thereof.

25. The processed legumes foodstuff according to claim 24 wherein the other LAB is selected from the group consisting of Lactobacillus plantarum CCRC10069, Lactococcus lactis subsp. lactis CCRC 12315, and Lactobacillus helveticus CCRC 14092.

26. A processed legumes foodstuff obtained by the method according to claim 17.

27. The processed legumes foodstuff according to claim 23 herein the legumes are at least one selected from the group consisting of soybean, black soybean and mixture thereof.

28. The processed legumes foodstuff according to claim 25 wherein the legumes are at least one selected from the group consisting of soybean, black soybean and mixture thereof.

29. A processed legumes foodstuff obtained by the method according to claim 17 and then sterilized at a temperature of from 95 to 115° C., shaped, and partly dried to a cheese-like product.

30. A bacteriocin produced by Pediococcus pentosaceus YJL according to claim 1.

31. The bacteriocin according to claim 30, which is an antibacterial substance having a molecular weigh of from 20 to 30 kDa.

32. A bacteriocin produced by Pediococcus pentosaceus YJS according to claim 2.

33. The bacteriocin according to claim 32, which is an antibacterial substance having a molecular weigh of from 20 to 30 kDa.
